(19) United States
(12) Patent Application Publication
(10) Pub. No.: US 2003/0033144 A1
(43) Pub. Date: Feb. 13, 2003

(54) Integrated sound input system

(75) Inventors: Kim E. Silverman, Mountain View, CA (US); Laurent J. Cerveau, Paris (FR); Matthias U. Neeracher, Cupertino, CA (US)

Correspondence Address: BEYER WEAVER & THOMAS LLP, P.O. BOX 778, BERKELEY, CA, 94704-0778, US

(73) Assignee: Apple Computer, Inc.

(21) Appl. No.: 10/172,593

(22) Filed: Jun. 13, 2002

Related U.S. Application Data
(60) Provisional application No. 60/311,025, filed on Aug. 8, 2001.
(60) Provisional application No. 60/311,026, filed on Aug. 8, 2001.

(51) Int. Cl. G10L 15/00

(52) U.S. Cl. 704/233

(57) ABSTRACT

A method for speech recognition is provided. Generally, a first signal is generated from a first microphone. The first signal is transformed to coefficients. The coefficients from the first signal are inputted to a multiple channel noise rejection device. A second signal is generated from a second microphone. The second signal is transformed to coefficients. The coefficients from the second signal are inputted to the multiple channel noise rejection device. Coefficients from the multiple channel noise rejection device, which are dependent on coefficients from the first signal and coefficients from the second signal, are provided to an acoustic model selector. Acoustic model hypotheses are chosen based on the coefficients from the multiple channel noise rejection device.

### RELATED APPLICATIONS

This application claims priority under 35 U.S.C. 119(e) of the U.S. Provisional Application No. 60/311,025, entitled “INTEGRATED SOUND INPUT SYSTEM”, filed Aug. 8, 2001 by inventors Kim E. Silverman, Laurent J. Cerveau, and Matthias U. Neeracher, and to the U.S. Provisional Application No. 60/311,026, entitled “SPACING FOR MICROPHONE ELEMENTS”, filed Aug. 8, 2001 by inventors Kim E. Silverman and Devang K. Naik, which are incorporated by reference.

### FIELD OF THE INVENTION

The present invention relates generally to computer systems. More particularly, the present invention relates to speech processing for computer systems.

### BACKGROUND OF THE INVENTION

Computer systems, such as speech recognition systems use a microphone to capture sound.

To facilitate discussion, FIG. 1 is a bird's eye view of a top view of a computer system being used for speech recognition. A computer 100 has a microphone 104, which is used for speech recognition. A user 108 may sit directly in from on the microphone 104 to provide oral commands 112, which may be recognized by the computer. The oral commands 112 are picked up by the microphone 104 to generate a signal, which is interpreted as a command. Background noise, which may be caused by a non-user 116 speaking 120 or making other noise or other objects making noise or echoes 124 of the oral commands. Speech recognition software in the computer 100 currently tries to screen out background noise. If the computer 100 does not successfully do this, the noise from the echo 124 or the non-user 116 or other noise may be interpreted as a command causing the computer 100 to perform an undesired action. One way computers in the prior art is to have the computer continuously monitor the spectral characteristics of the microphone and the background noise and to use these measurements to adjust the computer to the background noise so that background noise may be more easily screened. In addition the computer 100 may measure and normalize the user's speech spectral characteristics so that the computer looks for a signal with the measure user speech spectral characteristics. One of the difficulties with the approach is if the user changes speech spectral characteristics, such as by turning away from the microphone or changing the distance to the microphone, the computer 100 may not recognize commands from the user 108 until the computer 100 has reset the user's spectral characteristics.

Non-integrated systems used for speech recognition may require extra steps where signal quality may be lost. A beam forming device may perform a Fast Fourier Transform on a signal and then do an inverse Fast Fourier Transform and a digital to analog conversion before the signal is sent to another device which performs an analog to digital conversion and another Fast Fourier Transform. The reason for these extra steps is that in a non-integrated system the beam forming device may use different Fast Fourier Transform coefficients than the other device, since in a non-integrated system it is not known which device would be connected to the beam forming device.

It would be desirable to provide a computer system with speech recognition, which is able to quickly distinguish user commands from background noise, with less loss of signal quality.

### SUMMARY OF THE INVENTION

To achieve the foregoing and other objects and in accordance with the purpose of the present invention, a variety of techniques for providing speech recognition is provided. Generally, a first signal is generated from a first microphone. The first signal is transformed to coefficients. The coefficients from the first signal are inputted to a multiple channel noise rejection device. A second signal is generated from a second microphone. The second signal is transformed to coefficients. The coefficients from the second signal are inputted to the multiple channel noise rejection device. Coefficients from the multiple channel noise rejection device, which are dependent on coefficients from the first signal and coefficients from the second signal, are provided to an acoustic model selector. Acoustic model hypotheses are chosen based on the coefficients from the multiple channel noise rejection device.

In an alternative embodiment speech recognition device is provided. Generally, a first microphone, which generates a first signal and a second microphone, which generates a second signal are connected to a multiple channel noise rejection device, wherein the multiple channel noise rejection device combines output from the first signal and the second signal and generates coefficients related to the first signal and the second signal. An acoustic model selector is able to receive the coefficients from the multiple channel noise rejection device. A coefficient database is connected to the acoustic model selector. An acoustic model database is connected to the acoustic model selector.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a bird's eye view of a top view of a computer system being used for speech recognition.

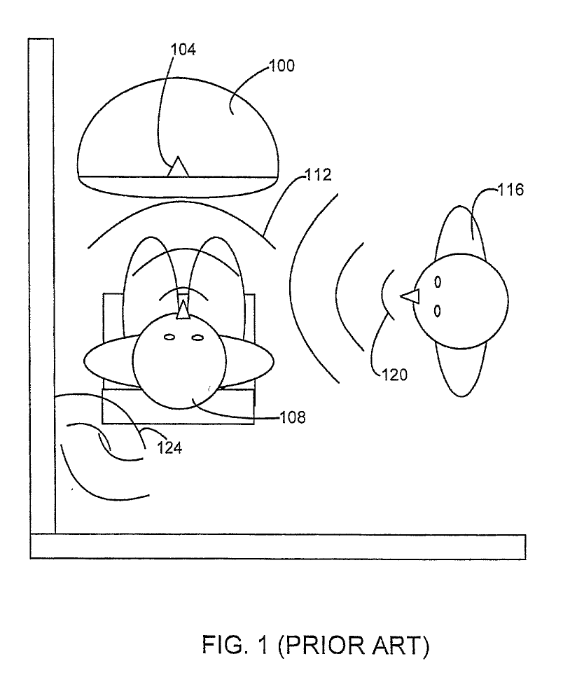

FIG. 2 is a high level view of a computer system, which may be used in an embodiment of the invention.

FIG. 3 is a high level flow chart for the working of the computer system.

FIGS. 4A and 4B illustrate a computer system, which is suitable for implementing embodiments of the present invention.

FIG. 5 is a schematic view of a distributed system that may be used in another embodiment of the invention.

FIG. 6 is a more detailed schematic view of the communications device shown in FIG. 5.

FIG. 7 is a more detailed schematic view of the server device shown in FIG. 5

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order to not unnecessarily obscure the present invention.

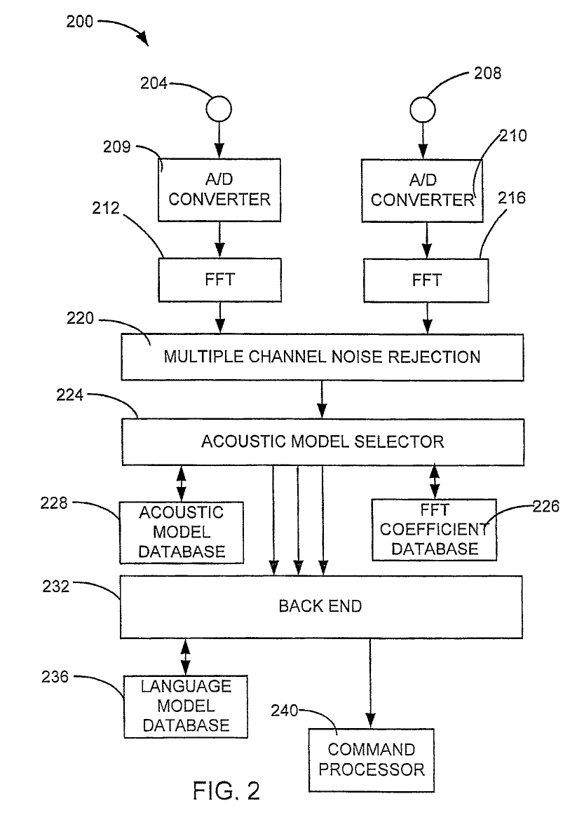

To facilitate discussion, FIG. 2 is a high level view of a speech recognition system 200 with a built in first microphone 204 and a built in second microphone 208, which may be used in an embodiment of the invention. The first microphone 204 is connected to a first analog to digital converter 209. The second microphone 208 is connected to a second analog to digital converter 210. The first analog to digital converter 209 is connected to a first Fast Fourier Transform (FFT) device 212. The second analog to digital converter 210 is connected to a second Fast Fourier Transform (FFT) device 216. The first and second FFT devices 212, 216 are connected to a multiple channel noise rejection device 220. The multiple channel noise rejection device 220 is connected to an acoustic model selector 224. The acoustic model selector 224 is connected to an FFT coefficient database 226, an acoustic model database 228, and a back end 232. The back end 232 is connected to a language model database 236 and a command processor 240.

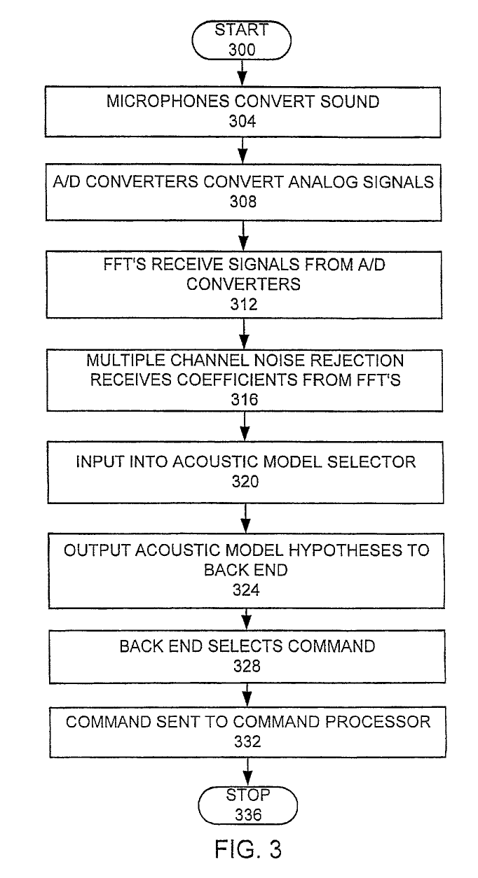

FIG. 3 is a high level flow chart for the working of the speech recognition system 200. The first microphone 204 and second microphone 208 receive sound and convert the sound to an electrical signal (step 304). The first microphone 208 feeds an electrical signal to the first analog to digital converter 209, and the second microphone 212 feeds an electrical signal to the second analog to digital converter 210. The first and second analog to digital converters 209, 210 convert analog signals to digital signals (step 308). The digital signals provide a voltage amplitude at set time intervals according to the voltage amplitude of the analog signal at the set time intervals. The digital signal from the first analog to digital converter 209 is fed to the first FFT device 212, which converts the output of the first analog to digital converter 209 from the time domain to the frequency domain. The digital signal from the second analog to digital converter 210 is fed to the second FFT device 216 (step 312). The first and second FFT devices 212, 216 convert the digital signal signifying amplitude with respect to time to FFT coefficients. The FFT coefficients are transmitted to the multiple channel noise rejection device 220 (step 316). The multiple channel noise rejection device 220 processes the FFT coefficients from the first FFT device 212 and the second FFT device 216. The multiple channel noise rejection device 220 uses a noise rejection process, such as beam forming, which is used to improve the signal to noise ratio, or off axis rejection, which is used to eliminate undesirable signals. Such noise rejection methods are known in the art. This processing may cause an FFT coefficient from the first FFT device 212 and an FFT coefficient from the second FFT device 216 to be combined to a single FFT coefficient. FFT coefficients from the multiple channel noise rejection device 220 are transmitted to the acoustic model selector 224 (step 320). The acoustic model selector 224 accesses an FFT coefficient database 226 and the acoustic model database 228 to provide acoustic model hypotheses. The acoustic model hypotheses are phonemes, which are consonance and vowel sounds used by a language, which the acoustic model selector 224 selects as the closest match between the received FFT coefficients and the acoustic models. The selected plurality of acoustic models is sent from the acoustic model selector 224 to the back end 232 (step 324). The back end 232 compares the selected plurality of acoustic models with a language model, which is a model of what can be spoken, in a language model database 236, and determines a command (step 328). Generally, several acoustic model hypotheses are sent from the acoustic model selectors 224 to the back end 232. The back end 232 processes the acoustic model hypotheses until an acoustic model hypothesis is chosen. The determined command is sent to a command processor 240 (step 332).

The acoustic model selector 224 and back end 232 may act simultaneously, with the acoustic model selector 224 continuously generating many hypotheses of what the computer thinks may be the phonemes from the captured speech and the back end 232 continuously eliminating hypotheses from the acoustic model selector 224 according to what is can be said until a single hypotheses remains, which is then designated as the command. The command may represent any type of input such as an interrupt or text input.

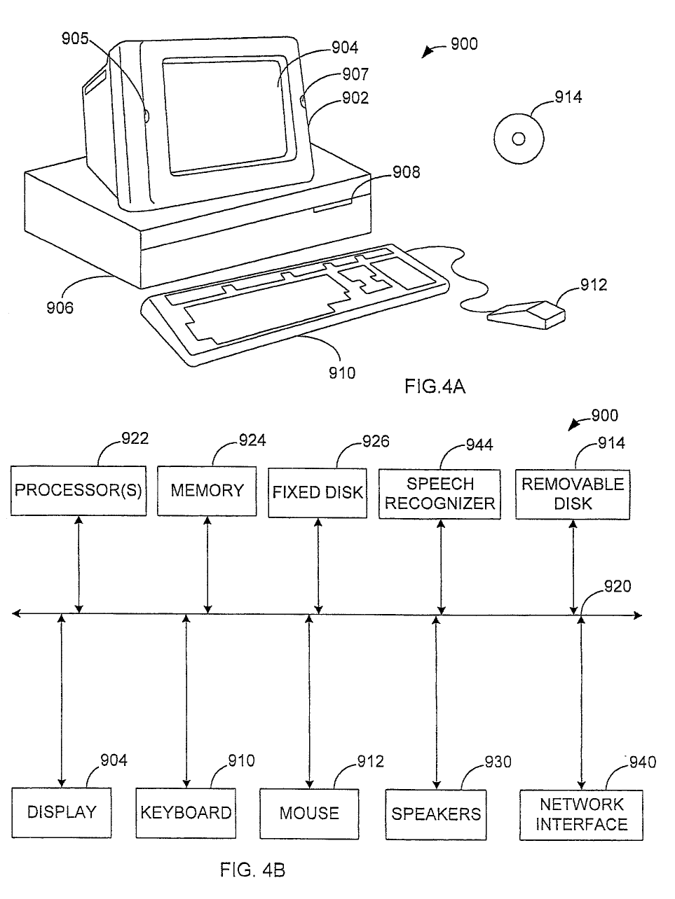

FIGS. 4A and 4B illustrate a computer system, which is suitable for implementing embodiments of the present invention. FIG. 4A shows one possible physical form of the computer system. Of course, the computer system may have many physical forms ranging from an integrated circuit, a printed circuit board, and a small handheld device up to a desktop personal computer. Computer system 900 includes a monitor 902 with a display 904, first microphone 905, and second microphone 907, a chassis 906, a disk drive 908, a keyboard 910, and a mouse 912. Disk 914 is a computer-readable medium used to transfer data to and from computer system 900.

FIG. 4B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bidirectionally to CPU 922; it provides additional data storage capacity and may also include any of the computer-readable media described below. Fixed disk 926 may be used to store programs, data, and the like and is typically a secondary storage medium (such as a hard disk) that is slower than primary storage. It will be appreciated that the information retained within fixed disk 926, may, in appropriate cases, be incorporated in standard fashion as virtual memory in memory 924. Removable disk 914 may take the form of any of the computer-readable media described below. A speech recognizer 944 is also attached to the system bus 920. The speech recognizer 944 may comprise the first microphone 905, the second microphone 907, and the other structure illustrated in FIG. 2.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing. The chassis 906 may be used to house the fixed disk 926, memory 924, network interface 940, and processors 922.

In addition, embodiments of the present invention may further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

The speech recognizer 944 is integrated in a single computer system in this embodiment. The advantages of integrating the speech recognizer in a single computer system are provided by an integrated design. Such a system would allow the acoustic model selector 224 to use the same FFT coefficients as the multiple noise rejection device 220. This would allow the FFT coefficients to be sent from the multiple noise rejection device 220 to the acoustic model selector 224 without going through an inverse FFT or an analog to digital converter, which would add additional signal quality losses and are computationally intensive. In addition, microphones have different characteristics such as gain and directionality. In addition, the mounting of the microphone to the display has different characteristics such as the location of the microphones, the rigidness of the mounting, the housing around the microphone, the wire path of the microphones, and air gaps around the microphone. By building the microphones into the integrated single computer system, noise from these characteristics may be minimized. For example, the wire path of the microphones may be placed to minimize electromagnetic interference from the display. For built in microphones, housing may be provided to reduce air currents around the microphone to minimize noise from the air currents. In addition, the algorithm used by the multiple channel noise rejection device 224 may be designed to take into account these microphone, placement, and mounting characteristics. The algorithm used by the multiple channel noise rejection device 224 may be designed to take into account microphone, placement, and mounting characteristics to provide tracking of the speaker or signal source.

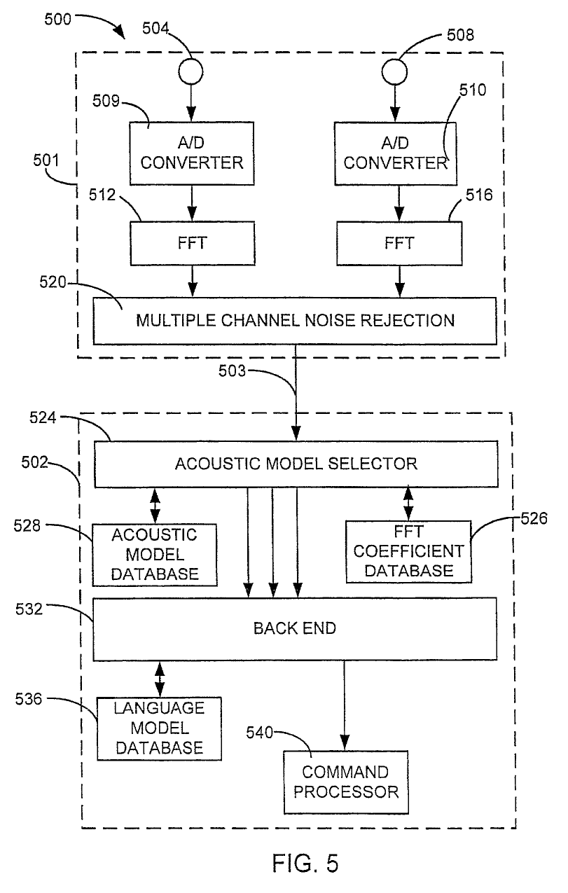

FIG. 5 is a schematic view of a distributed system 500 that may be used in another embodiment of the invention. The distributed system 500 comprises a communications device 501 and a server device 502, which communicates to the communications device 501 over a network connection 503. The communications device 501 houses a first microphone 504, second microphone 508, a first analog to digital converter 509, a second analog to digital converter 510, a first Fast Fourier Transform device 512, a second Fast Fourier Transform device 516, and a multiple channel noise rejection device 520. The server device 502 houses an acoustic model selector 524, an acoustic model database 528, an FFT coefficient database 526, a back end 532, a language model database 536, and a command processor 540. The network connection 503 may be a communications connection, such as a wireless connection, a telephone connection, an Ethernet connection, or an Internet connection. Even though the over all distributed system 500 is integrated in that the communications device 501 shares the Fast Fourier Transform coefficients with the server device 502 and the multichannel noise rejection device is tailored to the system, the distributed system 500 is distributed in that the communications device 501 may be physically separated from the server device 502, possibly separated by a great distance. Since the communications device 501 shares FFT coefficients with the server device 502 and the server device 502 is able to use the FFT coefficients from the communications device 501 an inverse FFT and further digital to analog conversion may be avoided, allowing the maintenance of signal quality for improved speech recognition. In addition, the transmission of the FFT coefficients may allow the reduction of signal bandwidth.

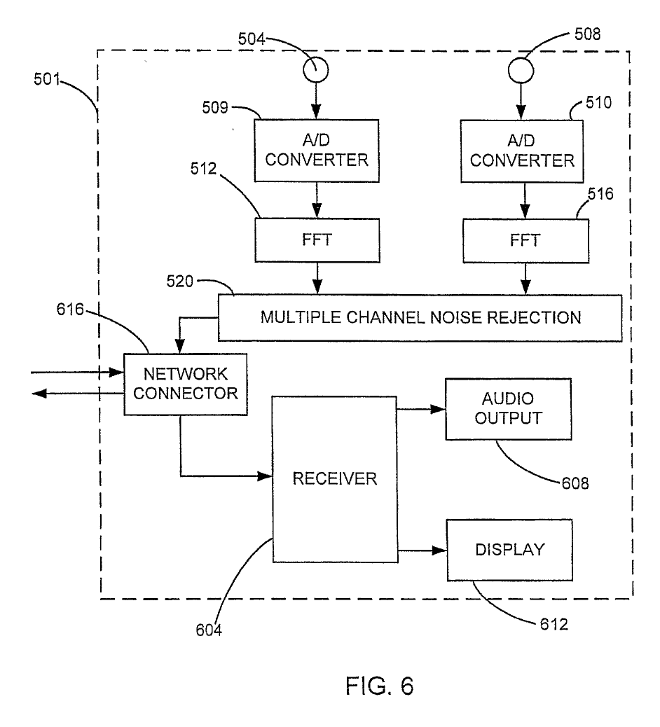

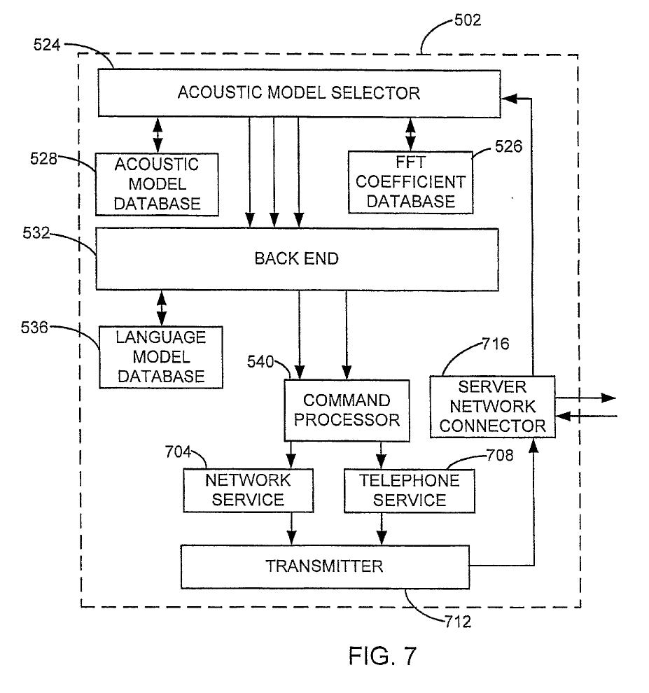

FIG. 6 is a schematic view of the communications device 501 shown in FIG. 5, which schematically illustrates other devices that may be provided in a preferred embodiment of the communications device 501. In this embodiment, the communications device 501 further comprises a receiver 604, an audio output 608, and a display 612. A network connector 616 may be built into the communications device 501 and to communicate over the network connection 503. FIG. 7 is a schematic view of the server device 502 shown in FIG. 5, which illustrates other devices that may be provided in a preferred embodiment of the server device 502. In this embodiment, the server device 502 further comprises a network service 704, a telephone service 708, and a transmitter 712. A server network connector 716 may be built into the server device and help to communicate over the network connection 503. One example of such a communications device 501 may be a wireless telephone with a display for viewing text or graphics information. One example of a server device 502 would be a point of presence or Internet service provider that may be called by the wireless telephone.

In operation, the communications device 501 may call the server device 502, where the network connection 503 may be part of a wireless phone service, which uses microwave signals to communicate between the communications device 501 and an antenna and then a network to provide a phone service between the antenna and the server device 502. In an alternative embodiment, the communications device 501 may be directly connected to the server device 502 by a microwave signal. A user may speak into the first microphone 504 and the second microphone 508. The first analog to digital converter 509 converts the analog signal from the first microphone 504 to a digital signal. The second analog to digital converter 510 converts the analog from the second microphone 508 to a digital signal. The digital signal from the first analog to digital converter 509 is fed to the first FFT device 512, which converts the output of the first analog to digital converter 509 from the time domain to the frequency domain. The digital signal from the second analog to digital converter 510 is fed to the second FFT device 516, which converts the output of the second analog to digital converter 510 from the time domain to the frequency domain. The first and second FFT devices 512, 516 convert the digital signal signifying amplitude with respect to time to FFT coefficients. The FFT coefficients are transmitted to the multiple channel noise rejection device 520. The multiple channel noise rejection device 520 processes the FFT coefficients from the first FFT device 512 and the second FFT device 516 to provide an FFT coefficient with an improved signal to noise ratio. The coefficients from the multiple channel noise rejection device 520 are transmitted by the network connector 616 over the network connection 503 to the server network connector 716 of the server device 502.

The sever network connector 716 of the server device 502 transmits the FFT coefficients to the acoustic model selector 524. The acoustic model selector 524 accesses an FFT coefficient database 526 and the acoustic model database 528 to provide acoustic model hypotheses. The acoustic model hypotheses are phonemes, which are consonance and vowel sounds used by a language, which the acoustic model selector 524 selects as the closest match between the received FFT coefficients and the acoustic models. The selected plurality of acoustic models is sent from the acoustic model selector 524 to the back end 532. The back end 532 compares the selected plurality of acoustic models with a language model, which is a model of what can be spoken, in a language model database 536, and determines a command. The determined command is sent to a command processor 540. The command processor 540 in this example may decide to forward the command to either a network service 704 or to a telephone service 708. The network service 704 may be an Internet service provided by the server device 502. The command may be a hypertext transfer protocol or another command that allows navigation around the Internet. The network service 704 may locate a web page according to the command and send the web page to the transmitter 712, which forwards the web page through the server network connector 716 and the network connection 503 to the communications device 501. The network connector 616 of the communications device 501 receives the web page data and forwards it to the receiver 604, which forwards the web page data to the display 612, which displays the web page.

The command processor 540 may in the alternative transmit the command to the telephone service 708, which may send a digital command over a telephone network to another Internet service. The other Internet service may see the digital command as a command generated by a computer over a modem, even though the command was generated orally. In addition to transmitting a graphics or text display from the server device 502 to the communications device, information from the server device 502 may be provided as an audio message. In such a case, the receiver 604 of the communications device 501 transmits the signal to the audio output 608 instead or in addition to the display 612.

The communications device 501 may have conventional telephone parts in addition to the speech recognition parts. The communications device 501 determines whether to send the FFT coefficients or the conventional audio signal.

The wireless telephone service provider may act as a point of presence or ISP, which may provided Internet access without dialing into an ISP. In such a case, all messages, even conventional telephone calls may be sent as FFT coefficients.

In another embodiment of the invention the Fast Fourier devices may be replaced by other devices that allow the representation of a signal by coefficients which may provide frequency based spectral conversions, such as linear predictive analysis.

While this invention has been described in terms of several preferred embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A speech recognition device, comprising:
a first microphone, which generates a first signal;
a second microphone, which generates a second signal;
a multiple channel noise rejection device connected to the first microphone and the second microphone, wherein the multiple channel noise rejection device combines output from the first signal and the second signal and generates coefficients related to the first signal and the second signal;
an acoustic model selector, which is able to receive the coefficients from the multiple channel noise rejection device;
a coefficient database connected to the acoustic model selector; and
an acoustic model database connected to the acoustic model selector.

2. The speech recognition device, as recited in claim 1, wherein the acoustic model selector compares coefficients received from the multiple channel noise rejection device with coefficients in the database and with the acoustic model database to obtain acoustic model hypotheses.

3. The speech recognition device, as recited in claim 2, further comprising:
a first Fast Fourier Transform device connected between the first microphone and the multiple channel noise rejection device; and
a second Fast Fourier Transform device connected between the second microphone and the multiple channel noise rejection device.

4. The speech recognition device, as recited in claim 3, further comprising:
a back end connected to the acoustic model selector; and
a language model database connected to the back end.

5. The speech recognition device, as recited in claim 4, wherein the back end receives acoustic model hypotheses from the acoustic model selector and compares the acoustic model hypotheses with data in the language model database.

6. The speech recognition device, as recited in claim 5, wherein the first microphone, second microphone, first Fast Fourier Transform device, second Fast Fourier Transform device, and multiple channel noise rejection device form a communications device, and wherein the acoustic model selector, coefficient database, acoustic model database form a server device.

7. The speech recognition device, as recited in claim 6, wherein the multiple channel noise rejection device is tailored for characteristics of the first microphone and the second microphone.

8. A method for providing speech recognition, comprising the steps of:
generating a first signal from a first microphone;
transforming the first signal to coefficients;
inputting the coefficients from the first signal to a multiple channel noise rejection device;
generating a second signal from a second microphone;
transforming the second signal to coefficients;
inputting the coefficients from the second signal to the multiple channel noise rejection device;
providing coefficients from the multiple channel noise rejection device, which are dependent on coefficients from the first signal and coefficients from the second signal, to an acoustic model selector; and
choosing acoustic model hypotheses based on the coefficients from the multiple channel noise rejection device.

9. The method, as recited in claim 8, further comprising the step of choosing a command from a language model database based on the acoustic model hypotheses.
